(19) United States
(12) Patent Application Publication
(10) Pub. No.: US 2022/0130411 A1
(43) Pub. Date: Apr. 28, 2022

(54) DEFECT-DETECTING DEVICE AND DEFECT-DETECTING METHOD FOR AN AUDIO DEVICE

(71) Applicant: Institute For Information Industry, Taipei (TW)

(72) Inventors: Shih-Yu LU, Taipei (TW); Veeresha Ramesha ITTANGIHALA, Taipei (TW); Sung-Min LIAO, Taipei (TW); Shih-Kai LU, Taipei (TW); Hung-Tse LIN, Taipei (TW)

(21) Appl. No.: 17/096,894

(22) Filed: Nov. 12, 2020

(30) Foreign Application Priority Data
Oct. 23, 2020 (TW) 109136942

(51) Int. Cl. G10L 25/51; G10L 25/21; G10L 25/18; G06N 3/04; G06N 3/08

(52) U.S. Cl. CPC G10L 25/51; G10L 25/21; G06N 3/08; G06N 3/0454; G10L 25/18

(57) ABSTRACT

A defect-detecting device stores a plurality of audio image data and a target audio image data. The plurality of audio image data include image data of normal audio and image data of defective audio of a first audio device and image data of normal audio of a second audio device, and the target audio image data corresponds to the second audio device. The defect-detecting device generates a plurality of simulated audio image data according to the plurality of audio image data, and trains a defect detection model according to the simulated audio image data. The defect-detecting device also analyzes, through the defect detection model, the target audio image data, so as to determine whether the second audio device is defective.

### PRIORITY

This application claims priority to Taiwan Patent Application No. 109136942 filed on Oct. 23, 2020, which is hereby incorporated by reference in its entirety.

### FIELD

The present disclosure relates to a defect-detecting device and defect-detecting method for an audio device. More particularly, the present disclosure relates to a defect-detecting device and a defect-detecting method which provide samples of audio signals of defective audio for an audio device by referring to the audio signals of another audio device, and then detect whether the audio device is defective.

### BACKGROUND

In the traditional way of detecting the defect of an audio device, the audio signal emitted by the audio device may be analyzed to determine whether the audio device is defective (e.g., the sounding structure of the audio device being rubbed off, wire bonding, air leaking, emitting abnormal noises, containing foreign matter, etc.). Since the sound mode of each audio device varies with its type/model, it is necessary to collect the audio signals emitted by each type of the audio device during normal operation and when there is a defect in it (hereinafter referred to as “normal audio signal” and “defective audio signal”, respectively), so as to establish defect detection models corresponding to each of the various audio devices.

The defect detection model requires sufficient audio signal samples for training to make accurate judgments. However, the defective audio signal of some audio devices is not easy to obtain (the reason may be, e.g., there are few existing devices, the defective rate is quite low. etc.), which leads to the problems such as high time cost of training the defect detection model, inaccurate defect definition of the defect detection model, or even unsuccessful training of the defect detection model. In addition, whenever a new type of audio device appears, the traditional way of defect detection needs to recollect a large number of defect signals of the new audio device, which also leads to the problem of high time cost. Accordingly, an urgent need exists in the art to provide a device and method for defect detection without collecting an enormous defective audio signals of the target audio device.

### SUMMARY

To solve at least the aforesaid problems, the present disclosure provides a defect-detecting device for an audio device. The defect-detecting device may comprise a storage and a processor which is electrically connected with the storage. The storage may be configured to store a plurality of pieces of audio image data and a piece of target audio image data. The plurality of pieces of audio image data may comprise image data of normal audio of a first audio device, image data of defective audio of the first audio device, and image data of normal audio of a second audio device, and the target audio image data may correspond to the second audio device. The processor may be configured to generate a plurality of pieces of simulated audio image data according to the plurality of pieces of audio image data, and train a defect detection model according to the plurality of pieces of simulated audio image data. The processor may be further configured to analyze the target audio image data to determine whether the second audio device is defective.

To solve at least the aforesaid problems, the present disclosure also provides a defect-detecting method for an audio device. The defect-detecting method may be performed by a computing device. The computing device may store a plurality of pieces of audio image data and a piece of target audio image data. The plurality of pieces of audio image data may comprise image data of normal audio of a first audio device, defect audio image data of the first audio device, and image data of normal audio of a second audio device. The defect-detecting method may comprise the following steps:

generating a plurality of pieces of simulated audio image data according to the plurality of pieces of audio image data;

training a defect detection model according to at least the plurality of pieces of simulated audio image data; and

analyzing the target audio image data through the defect detection model to determine whether the second audio device is defective.

In summary, the defect-detecting method of the present disclosure simulates the simulated audio image data that may be used to train the defect detection model corresponding to the audio device to be detected by referring to the audio image data of the existing audio device. Therefore, the corresponding defect detection model may be trained even when the audio image data of the audio device to be detected is insufficient, and detect whether there are defects. As a result, the defect-detecting method of the present disclosure greatly reduces the time cost of re-collecting the audio signals (especially defective audio signals) for a specific type of audio device in the traditional method, and solves the problem that the insufficient audio image data of the audio device may lead to the unsuccessful training of the defect detection model.

What have described above is not intended to limit the present disclosure, but merely outlines the solvable technical problems, the usable technical means, and the achievable technical effects for a person having ordinary skill in the art to preliminarily understand the present disclosure. According to the attached drawings and the following detailed description, a person having ordinary skill in the art can further understand the details of various embodiments of the present disclosure.

### BRIEF DESCRIPTION OF THE DRAWINGS

The drawings are provided for describing various embodiments, in which:

FIG. 1 illustrates a defect-detecting device according to one or more embodiments of the present disclosure;

FIG. 2 illustrates a defect-detecting process according to one or more embodiments of the present disclosure; and

FIG. 3 illustrates a defect-detecting method according to one or more embodiments of the present disclosure.

### DETAILED DESCRIPTION

In the following description, the present disclosure will be described with reference to example embodiments thereof. However, these example embodiments are not intended to limit the present disclosure to any operations, environment, applications, structures, processes, or steps described in these example embodiments. Contents unrelated to the embodiments of the present disclosure or contents that shall be appreciated without particular description are omitted from depiction; and dimensions of elements and proportional relationships among individual elements in the attached drawings are only exemplary examples but not intended to limit the scope of the claimed invention. Unless stated particularly, same (or similar) reference numerals may correspond to same (or similar) elements in the following description. Unless otherwise specified, the number of each element described below may be one or more.

Terms used in this disclosure are only used to describe the embodiments, and are not intended to limit the scope of the claimed invention. Unless the context clearly indicates otherwise, singular forms “a” and “an” are intended to comprise the plural forms as well. Terms such as “comprising” and “including” indicate the presence of stated features, integers, steps, operations, elements and/or components, but do not exclude the presence of one or more other features, integers, steps, operations, elements, components and/or combinations thereof. The term “and/or” comprises any and all combinations of one or more associated listed items.

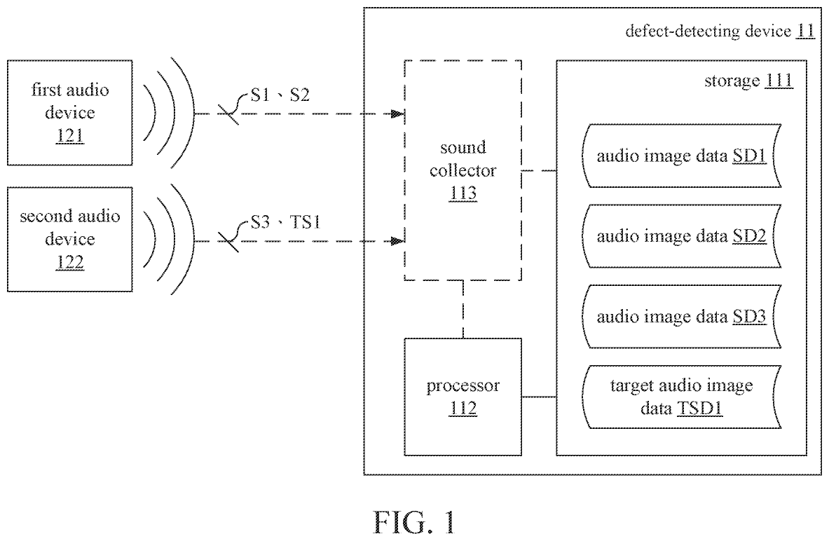

FIG. 1 illustrates a defect-detecting device according to some embodiments of the present disclosure. However, the contents shown in FIG. 1 are only for illustrating embodiments of the present disclosure, but not for limiting the scope of the claimed invention.

Referring to FIG. 1, a defect-detecting device 11 for audio devices may basically comprise a storage 111 and a processor 112 electrically connected with the storage 111. The electrical connection between the storage 111 and the processor 112 may be direct connection (i.e., connected not via other elements) or indirect connection (i.e., connected via other elements). The defect-detecting device 11 may be various types of computing devices, such as desktop computers, portable computers, mobile phones, portable electronic accessories (glasses, watch, etc.) or the like. The defect-detecting device 11 may detect whether an audio device is defective by analyzing the audio signal of the audio device, and the related details will be described later.

The storage 111 may be configured to store data generated by the defect-detecting device 11, data transmitted from an external device, or data input by the user. The storage 111 may comprise a first-level memory (which is also referred to as a main memory or an internal memory), and the processor 112 may directly read the instruction set stored in the first-level memory, and execute these instruction sets when needed. The storage 111 may optionally comprise a second-level memory (which is also referred to as an external memory or a secondary memory), and the second-level memory may transmit the stored data to the first-level memory through a data buffer. For example, the second-level memory may be, but is not limited to: a hard disk, an optical disk, etc. The storage 111 may optionally comprise a third-level memory, that is, a storage device that can be directly inserted into or removed from the computer, such as a mobile disk.

The storage 111 may store a plurality of pieces of audio image data SD1, SD2, and SD3, and a piece of target audio image data TSD1. Each of the audio image data SD1, SD2, and SD3 may respectively correspond to the audio signals S1 and S2 of the first audio device 121 and the audio signal S3 of the second audio device 122, and the audio signals S1, S2, and S3 may be the normal audio signal of the first audio device 121, the defective audio signal of the first audio device 121, and the normal audio signal of the second audio device 122, respectively. Therefore, the audio image data SD1, SD2, and SD3 may be a piece of image data of normal audio of the first audio device 121, a piece of image data of defective audio of the first audio device 121, and a piece of image data of normal audio of the second audio device 122, respectively. The target audio image data TSD1 may correspond to the target audio signal TS1 from the second audio device 122. The audio image data SD1, SD2, and SD3, and the target audio image data TSD1 may be used to respectively present, in forms of images, the audio signals S1 and S2 emitted by the first audio device 121 and the audio signals S3 and the target audio signal TS1 emitted by the second audio device 122. In some embodiments, the audio image data SD1, SD2 and SD3, and the target audio image data TSD1 may be two-dimensional time-frequency diagrams corresponding to the audio signals S1, S2 and S3, and the target audio signal TS1, such as but not limited to Mel spectrograms.

The processor 112 may be any of various microprocessors or microcontrollers capable of signal processing. The microprocessor or the microcontroller is a special programmable integrated circuit that has the functions of operation, storage, output/input, or the like, and may accept and process various coded instructions, thereby performing various logical operations and arithmetical operations, and outputting the corresponding operation results. The processor 112 may be programmed to interpret various instructions to process the data in the defect-detecting device 11 and execute various operational programs or applications.

In some embodiments, the defect-detecting device 11 may further comprise a sound collector 113, and the sound collector 113 may be electrically connected with the storage 111 and the processor 112. The sound collector 113 may be an electronic component capable of collecting (i.e., recording) sound, such as but not limited to a microphone. The sound collector 113 may receive the audio signals S1 and S2 from the first audio device 121, and receive the audio signal S3 and the target audio signal TS1 from the second audio device 122.

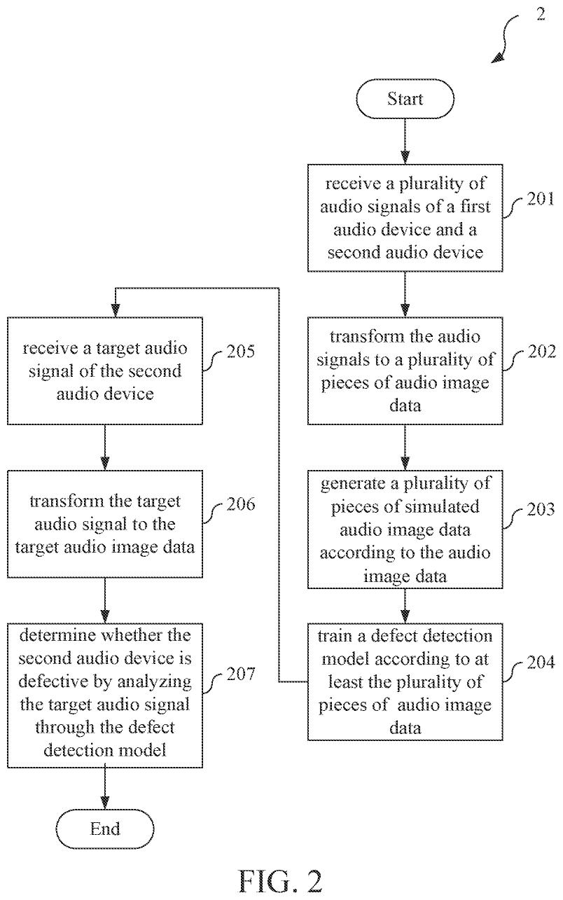

FIG. 2 illustrates a defect-detecting process according to one or more embodiments of the present disclosure. However, the contents shown in FIG. 2 are only for illustrating embodiments of the present disclosure, but not for limiting the scope of the claimed invention.

Referring to FIG. 1 and FIG. 2 simultaneously, the specific way for the defect-detecting device 11 to detect defects in an audio device may be presented in a defect-detecting process 2. The defect-detecting process 2 may comprise a plurality of actions 201-207. First, in action 201, the defect-detecting device 11 may receive the audio signals S1 and S2 emitted by the first audio device 121, and receive the audio signal S3 emitted by the second audio device 122. To be more specific, in some embodiments, the audio signals S1, S2, and S3 may be input from the outside to the defect-detecting device 11 through wired transmission (e.g., Universal Serial Bus (USB), network cable, or the like) or wireless transmission (e.g., Bluetooth, Wi-Fi, or the like). In some other embodiments, the audio signals S1, S2, and S3 may be received from the first audio device 121 and the second audio device 122 through the sound collector 113.

After obtaining the audio signals S1, S2, and S3, in action 202, the processor 112 may transform the audio signals S1, S2, and S3 into the audio image data SD1, SD2, and SD3. More particularly, in some embodiments, the processor 112 may perform a time-frequency analysis operation on the audio signals S1, S2, and S3 to generate the audio image data SD1, SD2 and SD3. The time-frequency analysis operation may at least be one of the Short-Time Fourier Transform (STFT) and the Constant-Q Transform (CQT).

In some embodiments, after obtaining the audio signals S1, S2, and S3, the processor 112 may first calculate a power spectral density for each of the audio signals S1, S2, and S3, and normalize the power spectral density. Then, the processor 112 may calculate a standard deviation according to the normalized power spectral density. If the standard deviation is not greater than a threshold, which means that the audio signal is roughly stable and has high degree of homogeneity, therefore, the processor 112 may decide to perform short-time Fourier transform on the audio signals S1, S2, and S3 accordingly, and generate the audio image data SD1, SD2, and SD3 according to the transformed frequencies. If the standard deviation is greater than a threshold, the processor 112 may decide to perform Constant-Q Transform on the audio signals S1, S2, and S3 accordingly, and generate the audio image data SD1, SD2, and SD3 according to the transformed frequencies.

After the audio image data SD1, SD2, and SD3 are transformed, in action 203, the processor 112 may generate a plurality of pieces of the simulated audio image data according to the audio image data SD1, SD2, and SD3, and each of the plurality of pieces of simulated audio image data may correspond to each of the audio image data SD1, SD2, and SD3. The simulated audio image data is the audio image data generated by the processor 112 based on the content of the audio image data SD1, SD2, and SD3, and it is used to simulate the image data (e.g., time-frequency diagram) corresponding to the sound emitted by the second audio device 122.

Specifically, in some embodiments, the processor 112 may first train a Generative Adversarial Network (GAN) according to at least one piece of image data of normal audio of the first audio device 121 (e.g., the audio image data SD1), at least one piece of image data of defective audio of the second audio device 121 (e.g., the audio image data SD2), and at least one piece of image data of normal audio of the second audio device 122 (e.g., the audio image data SD3). In some embodiments, the Generative Adversarial Network may be “CycleGAN”.

Since the Generative Adversarial Network can be used to generate another piece of image data based on image data, after the training is completed, the processor 112 may use the Generative Adversarial Network to generate the plurality of pieces of simulated audio image data based on the image data of normal or defective audio (e.g., audio image data SD1, audio image data SD2, and audio image data SD3). The Generative Adversarial Network may learn the characteristics of the normal audio signal of the second audio device 122 and the overall sounding characteristics of the first audio device 121, and then may simulate various types of audio image data of the second audio device 122, including the image data of defective audio of the second audio device 122. In this way, the signal samples of defective audio originally lacked by the second audio device 122 may be supplemented to facilitate the subsequent training of the defect detection model.

Each of the plurality of pieces of the simulated audio image data will correspond to the same condition of the audio image data SD1, SD2, and SD3 (i.e., belonging to the image data of normal audio or the image data of defective audio). In other words, the simulated audio image data simulated according to the image data of normal audio of the first audio device 121 is for simulating the sound emitted by an audio device in a normal condition. On the other hand, the simulated audio image data simulated according to the audio image data of the defective audio signal of the first audio device 121 is for simulating the sound emitted by an audio device in a defective condition.

After generating the simulated audio image data, in action 204, the processor 112 may train a defect detection model according to at least the plurality of pieces of simulated audio image data. Specifically, in some embodiments, the processor 112 may use at least the plurality of pieces of simulated audio image data to train a convolutional neural network (CNN) to obtain the defect detection model. Since the plurality of pieces of image data of defective audio is to simulate the sound emitted by the second audio device 122, the defect detection model may learn to distinguish between the image data of normal audio and the image data of defective audio of the second audio device 122 through training. In some embodiments, the processor 112 may further use other image data of normal audio of the second audio device 122 to train the defect detection model to improve the accuracy of its judgment.

After completing the training of the defect detection model, in action 205, the defect detection device 11 may receive the target audio signal TS1 emitted by the second audio device 122. In action 206, the processor 112 may transform the target audio signal TS1 into the target audio image data TSD1. The way for the processor 112 to transform the target audio signal TS1 into the target audio image data TSD1 may be the same as the above-mentioned way of transforming the audio signals S1, S2, and S3 into the audio image data SD1, SD2, and SD3, and thus will not be further described again herein.

Finally, in action 207, the processor 112 may analyze the target audio data TSD1 through the trained defect detection model, and then determine whether the second audio device 122 is defective according to the output result of the defect detection model.

In some embodiments, the processor 112 may additionally add labels of the corresponding type of defect (e.g., the sounding structure of the audio device being rubbed off, wire bonding, air leaking, emitting abnormal noises, containing foreign matter, etc.) to the simulated audio image data belonging to the image data of defective audio when training the defect detection model, so that the trained defect detection model may further identify the type of defect (if any) of the second audio device 122 corresponding to the target audio data TSD1.

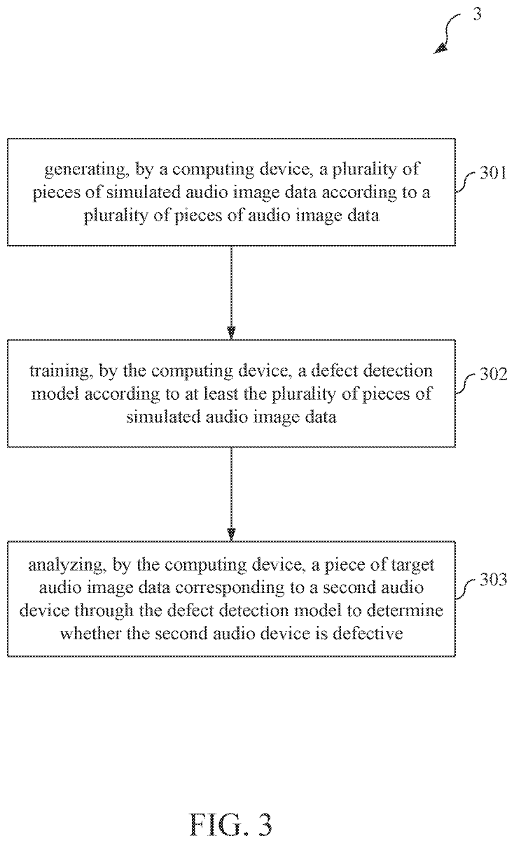

FIG. 3 illustrates a defect-detecting method according to one or more embodiments of the present disclosure. However, the contents shown in FIG. 3 are only for illustrating embodiments of the present disclosure, but not for limiting the scope of the claimed invention.

Referring to FIG. 3, a defect-detecting method 3 for audio devices may be performed by a computing device. The computing device may store a plurality of pieces of audio image data and a piece of target audio image data. The plurality of pieces of audio image data may comprise at least a piece of image data of normal audio of a first audio device, at least a piece of image data of defective audio of the first audio device, and at least a piece of image data of normal audio of a second audio device. The target audio image data may correspond to the second audio device. The defect-detecting method 3 may comprise the following steps:

generating a plurality of pieces of simulated audio image data according to the plurality of pieces of audio image data (labeled as 301);

training a defect detection model according to at least the plurality of pieces of simulated audio image data (labeled as 302); and

analyzing the target audio image data through the defect detection model to determine whether the second audio device is defective (labeled as 303).

In some embodiments, the defect-detecting method 3 may further comprise the following steps:

performing a time-frequency analysis operation on at least a normal audio signal of the first audio device, at least a defective audio signal of the first audio device, and at least a normal audio signal of the second audio device, so as to generate the plurality of pieces of audio image data.

In some embodiments, the defect-detecting method 3 may further comprise the following steps:

training a Generative Adversarial Network (GAN) model according to at least the plurality of pieces of audio image data; and

using the GAN model which has been trained to generate the plurality of pieces of simulated audio image data.

In some embodiments, regarding the defect-detecting method 3, the plurality of pieces of audio image data, the plurality of pieces of simulated audio image data, and the target audio image data may all be time-frequency diagrams, and the defect detection model may be a Convolutional Neural Network (CNN).

In some embodiments, the defect-detecting method 3 may further comprise the following steps:

calculating a power spectral density for each of the audio signals;

normalizing each power spectral density;

calculating a standard deviation according to each normalized power spectrum density;

performing a short-time Fourier transform on the audio signals to generate the plurality of pieces of audio image data if the standard deviation is not greater than a threshold; and

performing a Constant-Q Transform on the audio signals to generate the plurality of pieces of audio image data if the standard deviation is greater than the threshold.

In some embodiments, the defect-detecting method 3 may further comprise the following steps:

receiving a target audio signal from the second audio device; and

performing a time-frequency analysis operation on the target audio signal, so as to generate the target audio image data.

In some embodiments, regarding the defect-detecting method 3, the plurality of pieces of simulated audio image data may be generated by the computing device through a Generative Adversarial Network according to the plurality of pieces of audio image data.

Each embodiment of the defect-detecting method 3 basically corresponds to a certain embodiment of the defect-detecting device 11. Therefore, even though not all of the embodiments of the defect-detecting method 3 are described in detail above, those embodiments of the defect-detecting method 3 that are not thoroughly described shall be fully understood by a person having ordinary skill in the art simply by referring to the above description for the defect-detecting device 11.

The above disclosure is related to the detailed technical contents and inventive features thereof for some embodiments of the present invention, but such disclosure is not to limit the present invention. A person having ordinary skill in the art may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A defect-detecting device for an audio device, comprising:
a storage, being configured to store a plurality of pieces of audio image data and a piece of target audio image data, wherein the audio image data comprise image data of normal audio of a first audio device, image data of defective audio of the first audio device, and image data of normal audio of a second audio device, and the target audio image data correspond to the second audio device; and
a processor, being electrically connected with the storage and configured to:
generate a plurality of pieces of simulated audio image data according to at least the plurality of pieces of audio image data;
train a defect detection model according to at least the plurality of pieces of simulated audio image data; and
analyze the target audio image data through the defect detection model to determine whether the second audio device is defective.

2. The defect-detecting device of claim 1, wherein the processor is further configured to perform a time-frequency analysis operation on at least one normal audio signal of the first audio device, at least one defective audio signal of the first audio device, and at least one normal audio signal of the second audio device, so as to generate the plurality of pieces of audio image data.

3. The defect-detecting device of claim 1, wherein the processor trains a Generative Adversarial Network (GAN) model according to at least the plurality of pieces of audio image data, and uses the GAN model which has been trained to generate the plurality of pieces of simulated audio image data.

4. The defect-detecting device of claim 1, wherein the plurality of pieces of audio image data, the plurality of pieces of simulated audio image data, and the target audio image data are time-frequency domain diagrams, and the defect detection model is based on a Convolutional Neural Network (CNN).

5. The defect-detecting device of claim 1, wherein the processor is further configured to:
calculate a power spectral density for each of the audio signals;
normalize each power spectral density; and
calculate a standard deviation according to each normalized power spectrum density;
wherein:
if the standard deviation is not greater than a threshold, the processor performs a short-time Fourier transform on the audio signals to generate the plurality of pieces of audio image data; and
if the standard deviation is greater than the threshold, the processor performs a Constant-Q transform on the audio signals to generate the plurality of pieces of audio image data.

6. The defect-detecting device of claim 1, further comprising a sound collector electrically connected with the processor and the storage, wherein the sound collector is configured to receive a target audio signal from the second audio device, and the processor is further configured to perform a time-frequency analysis operation on the target audio signal to generate the target audio image data.

7. The defect-detecting device of claim 1, wherein the processor generates the plurality of pieces of simulated audio image data with a GAN according to the plurality of pieces of audio image data.

8. A defect-detecting method for an audio device, the defect-detecting method being performed by a computing device, the computing device storing a plurality of pieces of audio image data and a target audio image data, the audio image data comprising image data of normal audio of a first audio device, image data of defective audio of the first audio device, and image data of normal audio of a second audio device, the target audio image data corresponding to the second audio device, the defect-detecting method comprising the following steps:
generating a plurality of pieces of simulated audio image data according to the plurality of pieces of audio image data;
training a defect detection model according to at least the plurality of pieces of simulated audio image data; and
analyzing the target audio image data through the defect detection model to determine whether the second audio device is defective.

9. The defect-detecting method of claim 8, further comprising the following step:
performing a time-frequency analysis operation on at least one normal audio signal of the first audio device, at least one defective audio signal of the first audio device, and at least one normal audio signal of the second audio device, so as to generate the plurality of pieces of audio image data.

10. The defect-detecting method of claim 8, further comprising the following steps:
training a Generative Adversarial Network (GAN) model according to at least the plurality of pieces of audio image data; and
using the GAN model which has been trained to generate the plurality of pieces of simulated audio image data.

11. The defect-detecting method of claim 8, wherein the plurality of pieces of audio image data, the plurality of pieces of simulated audio image data, and the target audio image data are time-frequency domain diagrams, and the defect detection model is based on a Convolutional Neural Network (CNN).

12. The defect-detecting method of claim 8, further comprising the following steps:
calculating a power spectral density for each of the plurality of pieces of audio signals;
normalizing each power spectral density; and
calculating a standard deviation according to each power spectrum density that has been normalized;
performing a short-time Fourier transform on the audio signals to generate the plurality of pieces of audio image data if the standard deviation is not greater than a threshold; and
performing a Constant-Q transform on the audio signals to generate the plurality of pieces of audio image data if the standard deviation is greater than the threshold.

13. The defect-detecting method of claim 8, further comprising the following steps:
receiving a target audio signal from the second audio device; and
performing a time-frequency analysis operation on the target audio signal to generate the target audio image data.

14. The defect-detecting method of claim 8, wherein the plurality of pieces of simulated audio image data are generated by the computing device through using a GAN and according to the plurality of pieces of audio image data.
